(19) United States
(12) Patent Application Publication
(10) Pub. No.: US 2026/0235094 A1
(43) Pub. Date: Aug. 13, 2026

(54) Canister and Automotive Vehicle Provided With the Same

(71) Applicant: AISAN KOGYO KABUSHIKI KAISHA, Obu-shi (JP)

(72) Inventors: Kenji Seki, Osaka-shi, Osaka (JP); Kunihisa Iwasaki, Osaka-shi, Osaka (JP); Kazuki Sakai, Osaka-shi, Osaka (JP)

(73) Assignee: AISAN KOGYO KABUSHIKI KAISHA, Obu-shi (JP)

(21) Appl. No.: 18/707,220

(22) PCT Filed: Nov. 4, 2022
(86) PCT No.: PCT/JP2022/041222

§ 371 Date: Apr. 30, 2026

(30) Foreign Application Priority Data
Nov. 5, 2021 (JP) 2021-181459

(51) Int. Cl. F02M 25/08; B01D 53/04

(52) U.S. Cl. CPC F02M 25/0854; B01D 53/0415; B01D 2259/40086; B01D 2259/4516; F02M 2025/0881

(57) ABSTRACT

A canister includes, when viewed in a direction orthogonal to a column axis P2 of a columnar molded heat storage material T, an average value of R1/r and R2/r is 0.57 or more, where R1 represents the length of a curved surface of a first edge portion connecting a first end surface M2 and a circumferential side surface M1 around the column axis P2, in a radial direction of the first end surface M2 on a first end side of the column axis P2, R2 represents the length of a curved surface of a second edge portion connecting a second end surface M3 and the circumferential side surface M1, in a radial direction of the second end surface M3 on a second end side of the column axis P2, and r represents the radius of a cross section in a direction orthogonal to the column axis P2.

### CROSS-REFERENCE TO RELATED APPLICATIONS

This application is the United States national phase of International Patent Application No. PCT/JP2022/041222 filed Nov. 4, 2022, and claims priority to Japanese Patent Application No. 2021-181459 filed Nov. 5, 2021, the disclosures of which are hereby incorporated by reference in their entireties.

### BACKGROUND OF THE INVENTION

### Field of the Invention

The present invention relates to a canister for ORVR systems that includes a casing internally provided with an adsorption layer capable of adsorbing and desorbing fuel vapor, and to an automotive vehicle provided with such a canister.

### Description of Related Art

In automobiles that use fuel, fuel vapor is generated by the evaporation of fuel in a fuel tank, and the fuel vapor is discharged to the ambient air at three timings, namely, during parking, traveling, and refueling. Among the three timings, the discharge of fuel vapor during refueling is caused due to fed fuel pushing fuel vapor in the tank out into the ambient air. To prevent the discharge of fuel vapor into the ambient air during refueling, a system (ORVR system: Onboard Refueling Vapor Recovery System) for adsorbing and recovering fuel vapor to be pushed out during refueling in a canister filled with an adsorbing material such as activated carbon, and a canister for use in such a system are being developed.

For example, JP 2005-233106A discloses a canister including a casing internally provided with an adsorption layer capable of adsorbing and desorbing fuel vapor, the adsorption layer containing activated carbon, and a molded heat storage material molded from microcapsules in which a phase change substance is encapsulated, the phase change substance being configured to absorb and release latent heat according to a temperature.

For example, JP 2001-145832A and JP 2003-311118A disclose, as such a heat storage material using a phase change substance, a powdery heat storage material obtained by encapsulating a phase change substance such as aliphatic hydrocarbon, which absorbs and releases latent heat in response to phase change, into microcapsules, and also disclose a latent-heat-storing adsorbing material obtained by mixing the powdery heat storage material with an adsorbing material and molding the mixture, or affixing the powdery heat storage material to a surface of a granular adsorbing material (activated carbon).

Meanwhile, a canister in an ORVR system needs to adsorb the fuel vapor that corresponds to the fed fuel volume and thus is larger in size than a normal canister, causing the problem in which the space in the vehicle is adversely affected.

To solve this problem and to downsize the canister disclosed in JP 2005-233106A, it is conceivable to reduce the particle diameters of the adsorbing material and the molded heat storage material to further improve adsorption performance, but in this case, the adsorption rate is expected to increase particularly due to the smaller particle diameter of the adsorbing material, increasing adsorption heat per unit time and resulting in a limitation in the adsorption performance.

The technique disclosed in JP 2005-233106A is not directed to an invention made in view of such circumstances, and there is still room for improvement in achieving a further improvement in adsorption ability.

### SUMMARY OF THE INVENTION

The present invention was made in view of the above-described problem, and it is an object to provide a canister that can be downsized, and in which: an adsorbing material in an adsorption layer has an improved adsorption ability; classification is suppressed while improving the dispersibility of a molded heat storage material with respect to the adsorbing material; and adsorption heat generated from the adsorbing material during adsorption is effectively stored in the heat storage material to suppress an increase in temperature of the adsorption layer and achieve a further improvement in the adsorption ability, as well as an automotive vehicle provided with such a canister.

A canister for achieving the above-described object is directed to a canister for an ORVR system comprising a casing internally provided with an adsorption layer capable of adsorbing and desorbing fuel vapor,
wherein the adsorption layer contains an adsorbing material, and a molded heat storage material molded from microcapsules in which a phase change substance is encapsulated, the phase change substance being configured to absorb and release latent heat according to a temperature,
the molded heat storage material is a heat storage material that has an average particle diameter of 0.9 mm or more and 1.6 mm or less and is molded in a columnar shape, and the adsorbing material has an average particle diameter of 1.0 mm or more and 1.8 mm or less, and
the molded heat storage material includes a first end surface on a first end side of a column axis of the columnar molded heat storage material, and a second end surface on a second end side of the column axis, when viewed in a direction orthogonal to the column axis, and an average value of R1/r and R2/r is 0.57 or more, where R1 represents a length of a curved surface of a first edge portion, which connects the first end surface and a circumferential side surface around the column axis, in a radial direction of the first end surface, R2 represents a length of a curved surface of a second edge portion, which connects the second end surface and the circumferential side surface, in a radial direction of the second end surface, and r represents a radius of a cross section of the molded heat storage material, in the direction orthogonal to the column axis.

According to the above-described characteristic configuration, the adsorbing material and the molded heat storage material have relatively small particle diameters, and particularly when the adsorbing material has a small particle diameter, particles of the adsorbing material per unit volume have a large external surface area and molecules of the fuel vapor to be adsorbed are likely to reach the surface of the adsorbing material. Furthermore, the fuel vapor having reached the surface of the adsorbing material moves through the adsorbing material. When the adsorbing material has a small particle diameter, the distance by which the fuel vapor moves through the adsorbing material is short, and thus the fuel vapor is likely to spread throughout the inside of the adsorbing material. For these reasons, the adsorption rate increases. The higher the adsorption rate is, the steeper the inclination of the breakthrough curve becomes when fixed layer adsorption is performed, allowing much more fuel vapor to be adsorbed until breakthrough occurs.

In addition, when the adsorbing material has a small particle diameter, adsorption heat is likely to occur due to the increased adsorption rate, causing the problem in which the temperature of the adsorbing material is likely to rise. In contrast, according to the present invention, by reducing the particle diameter of the molded heat storage material to increase the external surface area of particles of the molded heat storage material per unit volume and increase heat transfer area, the transfer of adsorption heat to the molded heat storage material is promoted, and an increase in temperature due to the smaller particle diameter of the adsorbing material is suppressed.

Accordingly, as in the above-described characteristic configuration, by reducing the particle diameter of the adsorbing material (and the particle diameter of the molded heat storage material), it is possible for the adsorbing material in the adsorption layer to exert adsorption ability more efficiently.

Furthermore, the inventors of the present invention have experimentally confirmed as shown in later-described experimental results that, as shown in FIG. 3, by setting the shape of the columnar molded heat storage material to a shape in which the average value of R1/r and R2/r is 0.57 or more, that is, a shape having rounded corners, it is possible to improve the mixability with the adsorbing material (dispersibility of the molded heat storage material with respect to the adsorbing material). Thus, by improving the mixability of the molded heat storage material with the adsorbing material, especially during refueling (during ORVR), the relatively large amount of adsorption heat generated from the adsorbing material whose adsorption rate has been improved due to the smaller particle diameter can be effectively stored, and high adsorption performance can be realized.

As described above, it is possible to realize a canister that can be downsized, and in which: an adsorbing material in an adsorption layer can have an improved adsorption ability; classification is suppressed while improving the dispersibility of a molded heat storage material with respect to the adsorbing material; and adsorption heat generated from the adsorbing material during adsorption is effectively stored in the heat storage material to suppress an increase in temperature of the adsorption layer and achieve a further improvement in the adsorption ability.

Note that the average particle diameters of the molded heat storage material and the adsorbing material are mass part average particle diameters specified by JIS K1474.

According to another characteristic configuration of the canister,
the molded heat storage material includes protrusions protruding from a surface of the molded heat storage material to an outer side, and each of the protrusions protruding from the surface to the outer side has a protrusion length of 50 μm or more, and
letting a largest distance from one point to another point on a circumference of a protrusion when viewed in a protruding direction in which the protrusion protrudes be a maximum diameter of the protrusion, and an average of maximum diameters of a plurality of protrusions be an average maximum diameter, the average maximum diameter of protrusions having a maximum diameter of 100 μm or more is 800 μm or less.

In the manufacturing process of molded heat storage materials, the process of rounding the corners of columnar molded heat storage materials generates fine powder of molded heat storage materials of several tens to several hundred of micrometers, and in the subsequent heat treatment process, the fine powder is bound to the surface of the molded heat storage materials and becomes protrusions, as shown in FIG. 6. Letting a largest distance from one point to another point on the circumference of a protrusion when viewed in a protruding direction in which the protrusion projects from the surface of the molded heat storage material to the outer side be the maximum diameter of the protrusion, and an average of the maximum diameters of a plurality of protrusions be an average maximum diameter, the protrusions with a large average maximum diameter prevent the surfaces of the molded heat storage material and the adsorbing material from coming into contact with each other when mixing them with each other, which prevents heat transfer between the molded heat storage material and the adsorbing material. Accordingly, in order to efficiently perform heat transfer between the molded heat storage material and the adsorbing material, the protrusions generated on the surface of the molded heat storage material preferably have a small average maximum diameter.

The inventors have experimentally confirmed that adsorption performance can be maintained at a certain level or above when the average maximum diameter of protrusions having a maximum diameter of 100 μm or more is 800 μm or less.

Here, a protrusion is defined as one that protrudes from the surface of the molded heat storage material to the outer side and has a protrusion length from the surface to the outer side of 50 μm or more. The average maximum diameter of protrusions having a maximum diameter of 100 μm or more is preferably 800 μm or less, more preferably 100 μm or more and 750 μm or less, furthermore preferably 150 μm or more and 700 μm or less.

According to another characteristic configuration of the canister,
a ratio of an average particle diameter of the molded heat storage material to an average particle diameter of the adsorbing material is 0.6 or more and 1.3 or less.

In the configuration described so far, when the ratio of the average particle diameter of the molded heat storage material to the average particle diameter of the adsorbing material is 0.6 or more and 1.3 or less, and both the adsorbing material and the molded heat storage material have relatively similar average particle diameters, the dispersibility of the molded heat storage material with respect to the adsorbing material in the adsorption layer can be improved, and classification can be suppressed.

According to another characteristic configuration of the canister,
letting an area of a projected image of an object be S, a circumferential length of the projected image be B, and a circumferential length of a circle having the same area as the area S of the projected image be C, a degree of circularity is defined as C/B, and
the adsorbing material has a degree of circularity of 0.90 or more and 1.0 or less, and the molded heat storage material has a degree of circularity of 0.90 or more and 1.0 or less.

Incidentally, in the later-described embodiment, the degree of circularity is defined as C/B, where an average of areas measured for 100 pieces of projected images of an object be S, an average of circumferential lengths measured for 100 pieces of the projected images be B, and a circumferential length of a circle having the same area as the average area S of the projected images be C.

As shown in FIG. 4, the inventors of the present invention have defined the degree of circularity as C/B, where an area of a projected image of an object is S, a circumferential length of the projected image is B, and a circumferential length of a circle having the same area as the area S of the projected image is C.

The inventors have confirmed in the later-described working examples that by setting the degree of circularity of both the adsorbing material and the molded heat storage material to 0.90 or more and 1.0 or less, the mixability (dispersibility of the molded heat storage material with respect to the adsorbing material) can be enhanced.

According to another characteristic configuration of the canister,
in addition to the feature in which the adsorbing material has a degree of circularity of 0.90 or more and 1.0 or less, and the molded heat storage material has a degree of circularity of 0.90 or more and 1.0 or less, a ratio of an average particle diameter of the molded heat storage material to an average particle diameter of the adsorbing material is 0.6 or more and 1.3 or less.

In the configuration described so far, with, in addition to the feature in which the adsorbing material has a degree of circularity of 0.90 or more and 1.0 or less, and the molded heat storage material has a degree of circularity of 0.90 or more and 1.0 or less, a feature in which the ratio of the average particle diameter of the molded heat storage material to the average particle diameter of the adsorbing material is 0.6 or more and 1.3 or less, and both the adsorbing material and the molded heat storage material have relatively similar average particle diameters, the dispersibility of the molded heat storage material with respect to the adsorbing material in the adsorption layer K can be improved, and classification can be suppressed.

According to another characteristic configuration of the canister,
the casing includes a tank port communicating with a fuel tank, a purge port for discharging purge gas, and an air port communicating with ambient air, the tank port and the purge port being provided at one end of the casing and the air port being provided at another end of the casing, and
the adsorption layer has a lower mass ratio of the molded heat storage material to the adsorbing material in a region adjacent to the tank port and the purge port than in a region adjacent to the air port.

When fuel vapor to be adsorbed is supplied from the tank port and is adsorbed to the adsorbing material, the fuel vapor sequentially generates adsorption heat from the upstream side while flowing through the adsorption layer from the tank port toward the air port, and part of the adsorption heat sequentially moves toward the downstream side, so the temperature on the air port side more easily rises than the temperature on the tank port side, and the temperature on the tank port side is relatively not likely to increase.

Accordingly, as in the above-described characteristic configuration, by setting a lower mass ratio of the molded heat storage material to the adsorbing material in the area adjacent to the tank port, it is possible to reduce the used amount of molded heat storage material, which is more expensive than the adsorbing material, on the tank port side, thereby reducing the cost.

When the adsorption layer is divided in the flowing direction of gas, it is preferable that the number of divided regions be actually 2 to 6, since increasing the number of divisions of the adsorption layer leads to an increase in the manufacturing cost.

According to another characteristic configuration of the canister,
the adsorption layer includes a tank-side adsorption region located close to the tank port and the purge port, and an air-side adsorption region located close to the air port, a mass ratio of the molded heat storage material to the adsorbing material in the air-side adsorption region is 0.15 or more and 0.80 or less, and a mass ratio of the molded heat storage material to the adsorbing material in the tank-side adsorption region is 0.05 or more and 0.50 or less.

As described above, when fuel vapor to be adsorbed is supplied from the tank port and is adsorbed to the adsorbing material, the fuel vapor sequentially generates adsorption heat from the upstream side while flowing through the adsorption layer from the tank-side adsorption region toward the air-side adsorption region, and part of the adsorption heat sequentially moves toward the downstream side, so the temperature more easily rises in the air-side adsorption region than in the tank-side adsorption region.

Accordingly, as in the above-described characteristic configuration, by setting a higher mass ratio of the molded heat storage material to the adsorbing material in the air-side adsorption region than in the tank-side adsorption region, it is possible to suppress an increase in the temperature on the air side, on which temperature tends to increase, and prevent a degradation of adsorption performance.

Incidentally, it is preferable to set a higher mass ratio of the molded heat storage material to the adsorbing material, the closer the position in the air-side adsorption region is to the air port.

According to another characteristic configuration of the canister,
the molded heat storage material in the tank-side adsorption region has a melting point that is lower than a melting point of the molded heat storage material in the air-side adsorption region.

As described above, since, when fuel vapor to be adsorbed is supplied from the tank port and is adsorbed to the adsorbing material, the fuel vapor sequentially generates adsorption heat from the upstream side while flowing through the adsorption layer from the tank-side adsorption region toward the air-side adsorption region, and part of the adsorption heat sequentially moves toward the downstream side, the temperature in the tank-side adsorption region is less likely to rise than in the air-side adsorption region.

As in the above-described characteristic configuration, by setting a lower melting point of the molded heat storage material in the tank-side adsorption region than the melting point of the molded heat storage material in the air-side adsorption region, it is possible to suppress the temperature of the adsorbing material in the tank-side adsorption region in the early stages of supply of fuel vapor, and improve the adsorption performance.

According to another characteristic configuration of the canister,
the canister further includes an on-off valve provided on a vapor flow path through which the fuel tank and the tank port are in communication with each other, the on-off valve being capable of opening and closing the vapor flow path.

According to the above-described characteristic configuration, by bringing the on-off valve into the closed state, for example, when the vehicle is stopped, it is possible to prevent fuel vapor from the fuel tank from being guided to the canister side. Therefore, for example, even when, in FIG. 1, a casing (or adsorption layer) of the canister that includes an adsorption layer of a small length L in the flowing direction X of the fuel vapor J is used, it is possible to prevent fuel vapor from leaking from the canister.

According to another characteristic configuration of the canister,
the molded heat storage material has a bulk density of 0.40 g/mL or more and 0.60 g/mL or less.

As the above-described characteristic configuration, by setting the bulk density of the molded heat storage material to 0.40 g/mL or more, it is possible to prevent the heat storage capacity of the heat storage material per unit volume from becoming too low, and when a certain volume of adsorbing material and a certain volume of molded heat storage material are mixed, adsorption heat can be easily maintained at the heat storage capacity or less, making it possible to favorably suppress the temperature rise.

On the other hand, by setting the bulk density of the molded heat storage material to 0.60 g/mL or less to prevent the bulk density of the molded heat storage material from becoming too high, the bulk density of the adsorbing material and the bulk density of the molded heat storage material can be relatively close to each other, making it possible to prevent a reduction in dispersibility.

According to another characteristic configuration of the canister,
the molded heat storage material has a latent heat of 150 J/g or more and 200 J/g or less.

As the above-described characteristic configuration, by setting the latent heat of the molded heat storage material to 150 J/g or more, the heat storage capacity of the heat storage material per unit volume is maintained at a certain level or above, making it possible to realize favorable heat storage effects. Also, the latent heat of the molded heat storage material depends on the latent heat of the raw material paraffin, the films of the microcapsules, and the amount of binder.

On the other hand, by setting the latent heat of the molded heat storage material to 200 J/g or less, it is possible to prevent such a situation in which the films of microcapsules become too thin, or the amount of binder becomes too small. Accordingly, the strength and durability of the molded heat storage material can be maintained at certain levels or above.

According to another characteristic configuration of the canister,
the adsorption layer in the casing of the canister has L/D/S of 0.07 or less, where L represents a length of the adsorption layer in a flowing direction of fuel vapor, S represents an area of a cross section of the adsorption layer taken along a direction orthogonal to the flowing direction, and D represents a diameter of a cross section of the adsorption layer that is taken along the direction orthogonal to the flowing direction and is a perfect circle.

It is known that a pressure loss when a fluid such as fuel vapor or air is circulated through a canister has a linear positive correlation to L/D/S. Typically, when the adsorbing material has a smaller particle diameter, the pressure loss of the canister increases, and thus it is necessary to design a smaller L/D/S so that the pressure loss is suppressed to a certain value or less. In this case, the fuel vapor tends to leak and the ORVR adsorption amount becomes smaller.

It was found that, as the above-described characteristic configuration, by using the adsorbing material and the molded heat storage material that are made of small particles, and setting L/D/S to 0.07 or less so that the pressure loss is suppressed to a certain value or less, it is possible to suppress a reduction in ORVR adsorption amount when L/D/S is reduced, due to the effects of increased adsorption rate and improved dispersibility.

An automotive vehicle for achieving the above-described object is preferably an automotive vehicle provided with the canister described so far.

According to the automotive vehicle provided with the canister described so far, it is possible to realize an automotive vehicle with a high fuel utilization efficiency in which the adsorption ability of adsorbing material in an adsorption layer can be improved, classification can be suppressed while improving the dispersibility of a molded heat storage material with respect to the adsorbing material, and adsorption heat generated from the adsorbing material during adsorption is effectively stored in the heat storage material to suppress an increase in temperature of the adsorption layer and achieve a further improvement in the adsorption ability.

### BRIEF DESCRIPTION OF THE DRAWINGS

FIG. 1 is a schematic configuration diagram of an automotive vehicle including a canister according to an embodiment.

FIG. 2 is a schematic configuration diagram of an automotive vehicle including a canister according to an embodiment.

FIG. 3 is a schematic configuration diagram of a heat storage material according to an embodiment.

FIG. 4 is a conceptual diagram illustrating the degree of circularity.

FIG. 5 shows an image of a molded heat storage material according to a working example obtained using a scanning electron microscope.

FIG. 6 shows an image of a protrusion, when viewed in a protruding direction, of a molded heat storage material according to Working Example 1 obtained using the scanning electron microscope.

FIG. 7 shows an image of a protrusion, when viewed in a direction orthogonal to the protruding direction, of the molded heat storage material according to Working Example 1 obtained using the scanning electron microscope.

### DESCRIPTION OF THE INVENTION

A canister 100 for ORVR according to an embodiment of the present invention and an automotive vehicle 200 provided with such a canister are directed to those that can be downsized, and in which: activated carbon in an adsorption layer can have an improved adsorption ability; classification is suppressed while improving the dispersibility of a molded heat storage material with respect to the activated carbon; and adsorption heat generated from the activated carbon during the adsorption is effectively stored in a heat storage material to suppress an increase in temperature of the adsorption layer and achieve a further improvement in the adsorption ability.

The following will describe the canister 100 according to the present embodiment and the automotive vehicle 200 provided with such a canister with reference to the drawings.

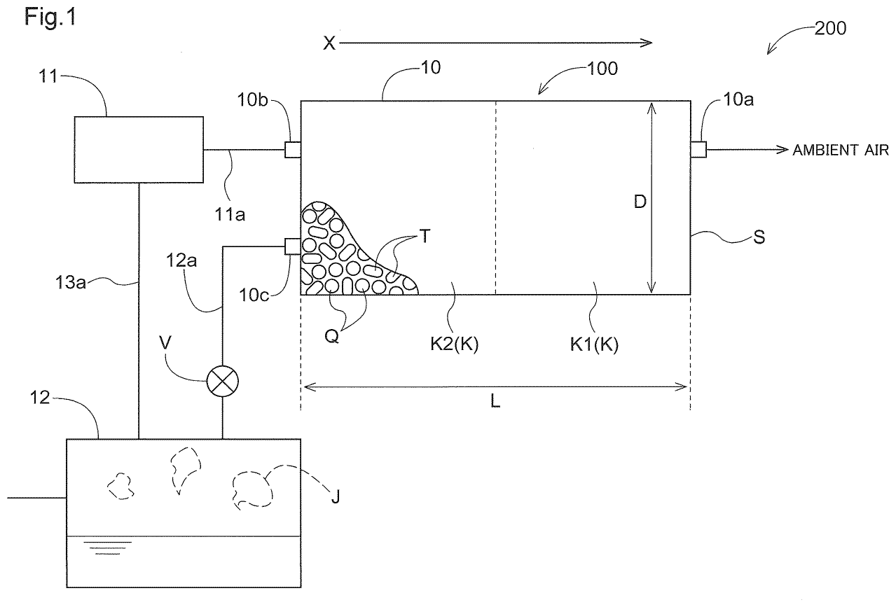

The canister 100 according to the present embodiment includes a casing 10 that is internally provided with an adsorption layer K capable of adsorbing fuel vapor J, and the canister 100 is favorably applicable to a commonly-known automotive vehicle. As shown in FIG. 1, the automotive vehicle 200 according to the present embodiment includes: a fuel tank 12 for storing fuel such as gasoline; the canister 100 configured to adsorb fuel vapor J vaporized in the fuel tank 12 particularly during refueling (ORVR) and guides the adsorbed fuel vapor J to an engine 11; and the engine 11 configured to obtain a shaft output by combusting fuel containing the fuel vapor J guided from the canister 100 and combustion air in a combustion chamber (not shown).

As shown in FIG. 1, the canister 100 includes the casing 10; a tank port 10c that communicates with the fuel tank 12 and is configured to receive fuel vapor J from the fuel tank 12; a purge port 10b configured to discharge the fuel vapor J desorbed in the canister 100 during desorbing operation to the engine 11; and an air port 10a that communicates with ambient air. The tank port 10c and the purge port 10b are provided at one end in a flowing direction X, and the air port 10a is provided at the other end in the flowing direction X. The purge port 10b communicates with the engine 11 via a purge flow path 11a, and the tank port 10c is connected to and communicates with the fuel tank 12 via a vapor flow path 12a, which is provided with an on-off valve V for switching the flow path between an open state and a closed state. Between the engine 11 and the fuel tank 12, there is a connection flow path 13a that connects the engine 11 and the fuel tank 12 so that they communicate with each other.

Meanwhile, the adsorption layer K contains an adsorbing material Q that adsorbs and desorbs the fuel vapor J and a molded heat storage material T that is molded from microcapsules in which a phase change substance that absorbs and releases latent heat according to a temperature is encapsulated.

The molded heat storage material T is obtained by molding a heat storage material together with a binder into granules, for example. The heat storage material is obtained by encapsulating a phase change substance that absorbs and releases latent heat in response to a temperature change in microcapsules. It is possible to use a known heat storage material in the form of microcapsules such as that disclosed in JP 2001-145832A, JP 2003-311118A, or the like.

The above-described phase change substance is constituted by, for example, an organic compound and an inorganic compound having a melting point of 10° C. or higher and 80° C. or lower, and examples of the phase change substance include: linear aliphatic hydrocarbons such as tetradecane, pentadecane, hexadecane, heptadecane, octadecane, nonadecane, eicosane, henicosane, and docosane; natural wax; petroleum wax; hydrated inorganic compounds such as LiXO₃·3H₂O, Xa₂SO₄·10H₂O, and Xa₂HPO₄·12H₂O; fatty acids such as capric acid and lauric acid; higher alcohols having 12 to 15 carbon atoms; and esters such as methyl palmitate and methyl stearate. Two or more compounds selected from the above-listed compounds may be used together as the phase change material.

Microcapsules that are formed by using any of these compounds as a core material through a known method such as a coacervation method or an in-situ method (interfacial reaction method) can be used. A known material such as melamine, gelatin, or glass can be used to form outer shells of the microcapsules. The heat storage material in the form of microcapsules preferably has a particle diameter of about several micrometers to several tens of micrometers. If the microcapsules are too small, the proportion of the outer shells constituting the capsules increases, and the proportion of the phase change material that repeatedly melts and solidifies relatively decreases, and therefore, the amount of heat stored per unit volume of the powdery heat storage material decreases. On the other hand, also if the microcapsules are too large, the capsules need to have certain strength, and accordingly, the proportion of the outer shells constituting the capsules increases, and the amount of heat stored per unit volume of the powdery heat storage material decreases.

The powdery heat storage material is molded together with a binder into a substantially columnar shape to obtain a granular molded heat storage material T. Various binders can be used, but a thermosetting resin such as a phenol resin or an acrylic resin is preferably used from the viewpoint of thermal stability, stability against a solvent, and strength, which are required when the binder is used in the canister 100. The granular molded heat storage material T is mixed with the adsorbing material Q, which also has a granular shape, and the mixture is used to obtain a heat storing effect.

Incidentally, the molded heat storage material T preferably has a latent heat of 150 J/g or more and 200 J/g or less.

Various known adsorbing material can be used as the adsorbing material Q. For example, activated carbon can be used as the adsorbing material Q. Granules individually molded or crushed to have predetermined dimensions can be used as the adsorbing material Q.

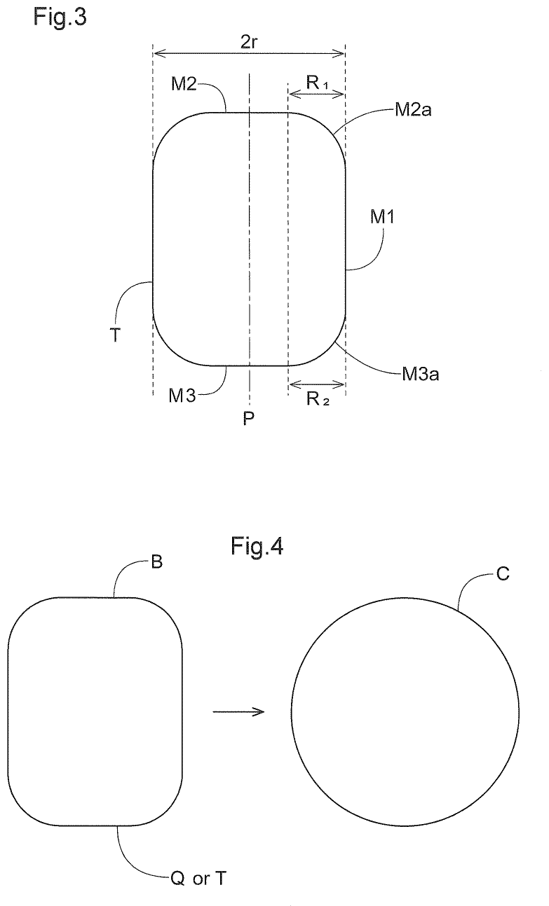

On the other hand, the molded heat storage material T that is molded into a columnar shape through extrusion molding as described above as shown in FIG. 3, for example, has a first end surface M2 on a first end side of a column axis P2 and a second end surface M3 on a second end side of the column axis P2 as viewed in a direction orthogonal to the column axis P2, and an average value of R1/r and R2/r is 0.57 or more, where R1 represents the length of a curved surface of a first edge portion M2a, which connects the first end surface M2 and a circumferential side surface M1 around the column axis P2, in a radial direction of the first end surface M2, R2 represents the length of a curved surface of a second edge portion M3a, which connects the second end surface M3 and the circumferential side surface M1, in a radial direction of the second end surface M3, and r represents the radius of a cross section of the molded heat storage material T taken along the direction orthogonal to the column axis P2.

By adopting such a shape having rounded corners, it is possible to improve mixability with the adsorbing material Q (dispersibility of the molded heat storage material T with respect to the adsorbing material Q), which was experimentally confirmed as shown in the later-described experimental results.

Note that the molded heat storage material T is shaped in such a manner that the length of the molded heat storage material T along the column axis P2 and the diameter of the cross section orthogonal to the column axis P2 do not differ very much from each other.

A concept “degree of circularity” is employed as the configuration that increases the dispersibility of the molded heat storage material T with respect to the adsorbing material Q in this way. As shown in FIG. 4, letting the area of a projected image of an object (the molded heat storage material T onto the adsorbing material Q) be S, the circumferential length of the object be B, and the circumferential length of a circle having the same area as the area S of the projected image be C, the degree of circularity is defined as C/B.

In this definition, preferably, the degree of circularity of the adsorbing material Q is 0.90 or more and 1.0 or less, and the degree of circularity of the molded heat storage material T is 0.90 or more and 1.0 or less.

The molded heat storage material T and the granular adsorbing material Q preferably have the same size as far as possible in order to suppress separation of the molded heat storage material T and the adsorbing material Q from each other with the passage of time and appropriately secure a gas flow path.

Specifically, when a mass average particle diameter specified by JIS K 1474 is used as an average particle diameter, the molded heat storage material T has an average particle diameter of preferably 0.9 mm or more and 1.6 mm or less, and the ratio of the average particle diameter of the molded heat storage material T to the average particle diameter of the adsorbing material Q is preferably 0.6 or more and 1.3 or less.

Also, it was confirmed in the later-described working example that, by setting the average particle diameter of the adsorbing material Q to 1.0 mm or more and 1.8 mm or less, it is possible to improve the amount of adsorption during ORVR.

The molded heat storage material preferably has a bulk density of 0.4 g/mL or more and 0.6 g/mL or less. Also, the adsorbing material Q desirably has a bulk density that is 0.2 times or more and 1.1 times or less of the bulk density of the molded heat storage material T, preferably 0.3 times or more and 1.0 times or less of the bulk density of the molded heat storage material T, and more preferably 0.4 times or more and 0.9 times or less of the bulk density of the molded heat storage material T. If the bulk density of the adsorbing material Q largely differs from the bulk density of the molded heat storage material T, the adsorbing material Q or the molded heat storage material T that is heavier than the other moves downward within the casing when the canister 100 is mounted in a vehicle or the like and vibration is applied to the canister 100, and separation of the adsorbing material Q and the molded heat storage material T progresses.

It is desirable that the mass ratio of the molded heat storage material T to the adsorbing material Q in the entire adsorption layer K is 5 mass % or more and 50 mass % or less, preferably 8 mass % or more and 48 mass % or less, and more preferably 10 mass % or more and 45 mass % or less. If the proportion of the molded heat storage material T is too small, the effects of suppressing a temperature change in adsorbing material Q due to heat storing effect cannot sufficiently achieved. In contrast, if the proportion of the molded heat storage material T is too large, the proportion of the adsorbing material Q decreases, resulting in a decrease in the amount of adsorption per unit volume of the canister 100. In the present invention, by using the heat storage material in which a phase change substance is encapsulated in microcapsule, a sufficient heat storing effect can be realized with a relatively small proportion of mixed molded heat storage material T, and a large amount of adsorption per unit volume of the canister 100 can be realized.

As shown in FIG. 1, the adsorption layer K may include a tank-side adsorption region K2, which is a region on a side on which the tank port 10c and the purge port 10b are provided, and an air-side adsorption region K1, which is a region on a side on which the air port 10a is provided. In the present embodiment, the tank-side adsorption region K2 and the air-side adsorption region K1 are separated from each other by a predetermined separation film or the like.

Here, for additional description on a mass ratio, the mass ratio of the molded heat storage material T to the adsorbing material Q is preferably set to different values for the tank-side adsorption region K2 and the air-side adsorption region K1, and the mass ratio of the molded heat storage material T to the adsorbing material Q in the tank-side adsorption region K2 is preferably 5 mass % or more and 50 mass % or less, and the mass ratio of the molded heat storage material T to the adsorbing material Q in the air-side adsorption region K1 is preferably 15 mass % or more and 80 mass % or less. With this configuration, by setting a larger mass ratio of the molded heat storage material T to the adsorbing material Q in the air-side adsorption region K1 than in the tank-side adsorption region K2, it is possible to suppress an increase in temperature on the air side, on which temperature during fueling (ORVR) tends to increase, and prevent the degradation of adsorption performance.

Also, the adsorption region may be divided into two or more regions. In this case, by increasing the proportion of the molded heat storage material T in a stepwise manner from the tank side region, where temperature does not tend to increase during refueling, toward the air side region, where temperature tends to increase, an appropriate ratio of the molded heat storage material T to the adsorbing material Q can be realized, and a large amount of adsorption per unit volume of the canister 100 can be achieved.

In other words, for example, the region of the adsorption layer K that is adjacent to the tank port 10c and the purge port 10b can have a lower mass ratio of the molded heat storage material T to the adsorbing material Q than in the region adjacent to the air port 10a.

Furthermore, in the present embodiment, the molded heat storage material T in the tank-side adsorption region K2 has a melting point (e.g., melting point of 25 degrees or more and 40 degrees or less) that is lower than a melting point (e.g., melting point of 40 degrees or more and 60 degrees or less) of the molded heat storage material T in the air-side adsorption region K1. With this, particularly, in the early stages of supply of fuel vapor J, it is possible to suppress the temperature of the adsorbing material Q in the tank-side adsorption region K2, improving the adsorption performance.

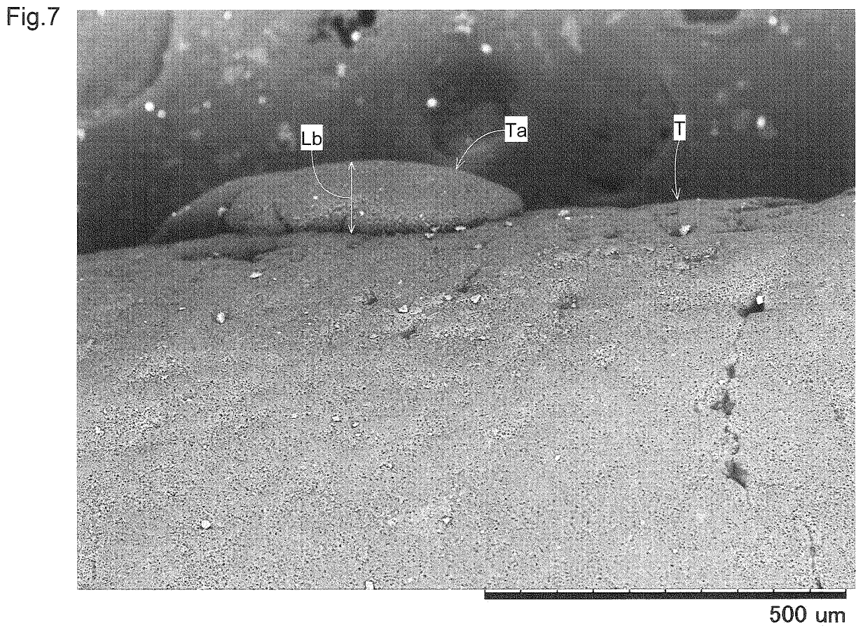

Also, as shown in FIGS. 6 and 7, a molded heat storage material T with a protrusion Ta protruding from the surface to the outer side can favorably be used.

For additional description, the protruding length (Lb in FIG. 7) of the protrusion Ta that protrudes from the surface of the molded heat storage material T to the outer side is 50 μm or more. Letting the largest distance (La in FIG. 6) from one point (LaX in FIG. 6) to another point (LaY in FIG. 6) on the circumference of a protrusion Ta when viewed in the protruding direction in which the protrusions Ta protrude (when viewed in the direction shown in FIG. 6) be the maximum diameter of the protrusion Ta, and an average of the maximum diameters be an average maximum diameter, the average maximum diameter of protrusions Ta having a maximum diameter of 100 μm or more is 800 μm or less.

Note that the average maximum diameter of the protrusions Ta is less than the average particle diameter of the molded heat storage material T.

As shown in FIG. 1, the dimensional shape of the casing 10 of the canister 100 in a columnar shape is preferably specified by L/D/S, where L represents the length of the adsorption layer in the flowing direction X of the fuel vapor J through the casing 10, S represents the area of a cross section of the adsorption layer, which is taken along a direction orthogonal to the flowing direction X of the fuel vapor J, and D represents the diameter of a cross section of the adsorption layer, which is taken along the direction orthogonal to the flowing direction X of the fuel vapor J and is assumed to be a perfect circle.

It is known that a pressure loss when a fluid such as fuel vapor or air is passed through a canister has a linear positive correlation to L/D/S. Typically, when the adsorbing material has a smaller particle diameter, the pressure loss of the canister increases, and thus it is necessary to design a smaller L/D/S so that the pressure loss is suppressed to a certain value or less. In this case, the fuel vapor is likely to leak and the ORVR adsorption amount becomes smaller.

Also in the present invention, it was found that, by using the adsorbing material and the molded heat storage material that are made of small particles, and setting L/D/S to 0.07 or less, and preferably 0.05 or less so that the pressure loss is suppressed to a certain value or less, it is possible to suppress a reduction in ORVR adsorption amount when L/D/S is reduced, due to the effects of increased adsorption rate and improved dispersibility.

### Manufacture of Molded Heat Storage Material for Working Example 1

Microcapsules that are covered with a melamine film and in which linear aliphatic hydrocarbon having a phase change temperature of 40° C. to 45° C. is encapsulated were manufactured by an existing method and the manufactured microcapsules were used.

To 100 mass parts of the above-described microcapsules, 13 mass parts of thermosetting phenolic organic binder (water soluble phenolic resin manufactured by DIC Corporation) and 24 mass parts of water were added and mixed. Then, the mixture was molded using an extruder (disk pelletter manufactured by Dalton Corporation). At this time, a screen dice with a 1.2 mm gap was used. Then, granules were prepared using a malmerizer (Dalton Corporation) at 600 rpm for 3 minutes. The prepared granules were dried for 40 minutes under conditions in which the temperature of the granules is 160° C. or higher, thereby obtaining a molded heat storage material.

### Manufacture of Molded Heat Storage Material for Working Examples 2 and 3

Microcapsules that are covered with a melamine film and in which linear aliphatic hydrocarbon having a phase change temperature of 40° C. to 45° C. is encapsulated were manufactured by an existing method and the manufactured microcapsules were used.

To 100 mass parts of the above-described microcapsules, 13 mass parts of thermosetting phenolic organic binder (water soluble phenolic resin manufactured by DIC Corporation) and 26 mass parts of water were added and mixed. Then, the mixture was molded using an extruder (disk pelletter manufactured by Dalton Corporation). At this time, a screen dice with a 1.2 mm gap was used. Then, granules were prepared using a malmerizer (Dalton Corporation) at 750 rpm for 1 minutes. The prepared granules were dried for 40 minutes under conditions in which the temperature of the granules is 160° C. or higher, thereby obtaining a molded heat storage material.

Note that a molded heat storage material T having protrusions Ta whose protrusion length (Lb in FIG. 7) from the surface thereof to the outer side is 50 μm or more was used as the molded heat storage material T in Working Examples 1 to 3, but the inventors have confirmed using a scanning electron microscope that the molded heat storage material T includes at least protrusions with the protrusion lengths (Lb in FIG. 7) of 98.1, 118, 149, and 175 μm.

### Manufacture of Molded Heat Storage Material for Comparative Example 1

Microcapsules that are covered with a melamine film and in which linear aliphatic hydrocarbon having a phase change temperature of 40° C. to 45° C. is encapsulated were manufactured by an existing method and the manufactured microcapsules were used.

To 100 mass parts of the above-described microcapsules, 13 mass parts of thermosetting phenolic organic binder (water soluble phenolic resin manufactured by DIC Corporation) and 24 mass parts of water were added and mixed. Then, the mixture was molded using an extruder (disk pelletter manufactured by Dalton Corporation). At this time, a screen dice with a 1.0 mm gap was used. Then, granules were prepared using a malmerizer (Dalton Corporation) at 500 rpm for 1 minute. The prepared granules were dried for 40 minutes under conditions in which the temperature of the granules is 160° C. or higher, thereby obtaining a molded heat storage material.

### Manufacture of Molded Heat Storage Material for Comparative Example 2

Microcapsules that are covered with a melamine film and in which linear aliphatic hydrocarbon having a phase change temperature of 40° C. to 45° C. is encapsulated were manufactured by an existing method and the manufactured microcapsules were used.

To 100 mass parts of the above-described microcapsules, 13 mass parts of thermosetting phenolic organic binder (water soluble phenolic resin manufactured by DIC Corporation) and 24 mass parts of water were added and mixed. Then, the mixture was molded using an extruder (disk pelletter manufactured by Dalton Corporation). At this time, a screen dice with a 1.2 mm gap was used. Then, granules were prepared using a malmerizer (Dalton Corporation) at 500 rpm for 1 minute. The prepared granules were dried for 40 minutes under conditions in which the temperature of the granules is 160° C. or higher, thereby obtaining a molded heat storage material.

### Manufacture of Molded Heat Storage Material for Comparative Example 3

Microcapsules that are covered with a melamine film and in which linear aliphatic hydrocarbon having a phase change temperature of 40° C. to 45° C. is encapsulated were manufactured by an existing method and the manufactured microcapsules were used.

To 100 mass parts of the above-described microcapsules, 10 mass parts of thermosetting phenolic organic binder (water soluble phenolic resin manufactured by DIC Corporation) and 24 mass parts of water were added and mixed. Then, the mixture was molded using an extruder (twin screw extruder manufactured by Dalton Corporation). At this time, a screen dice with a 1.5 mm gap was used. Then, granules were prepared using a malmerizer (Dalton Corporation) at 500 rpm for 1 minute. The prepared granules were dried for 40 minutes under conditions in which the temperature of the granules is 160° C. or higher, thereby obtaining a molded heat storage material.

### Manufacture of Molded Heat Storage Material for Reference Example 1

Microcapsules that are covered with a melamine film and in which linear aliphatic hydrocarbon having a phase change temperature of 40° C. to 45° C. is encapsulated were manufactured by an existing method and the manufactured microcapsules were used.

To 100 mass parts of the above-described microcapsules, 10 mass parts of thermosetting phenolic organic binder (water soluble phenolic resin manufactured by DIC Corporation) and 28 mass parts of water were added and mixed. Then, the mixture was molded using an extruder (twin screw extruder manufactured by Dalton Corporation). At this time, a screen dice with a 1.5 mm gap was used. Then, granules were prepared using a malmerizer (Dalton Corporation) at 500 rpm for 1 minute. The prepared granules were dried for 40 minutes under conditions in which the temperature of the granules is 160° C. or higher, thereby obtaining a molded heat storage material.

In Working Examples 1 to 3 and Comparative Examples 1 to 3, spherical activated carbon whose butane working capacity defined by ASTM-D5228 corresponds to 15 g/100 mL was used as the activated carbon.

In Reference Example 1, pellet shaped activated carbon whose butane working capacity defined by ASTM-D5228 corresponds to 15 g/100 mL was used as the activated carbon.

[Measurement Test according to Dispersibility and ORVR Adsorption Amount]

For Working Examples 1 to 3, Comparative Examples 1 to 3, and Reference Example 1, activated carbon serving as the adsorbing material Q whose average particle diameter and degree of circularity were adjusted, and the molded heat storage material T whose average particle diameter, degree of circularity, and R/r value were adjusted were placed in the casing 10 of a specified capacity and a specified shape, and the dispersibility and the ORVR adsorption amount were measured. Note that the average particle diameters, the degree of circularity, and the R/r values in Working Examples 1 to 3, Comparative Examples 1 to 3, and Reference Example 1 are as shown in Tables 1 and 2. Tables 1 and 2 also show the ratios of the average particle diameter of the molded heat storage material T to the average particle diameter of the activated carbon, and the bulk density and latent heat of the molded heat storage material T in Working Examples 1 to 3, Comparative Examples 1 to 3, and Reference Example 1.

Incidentally, in the test, an average particle diameter is a mass average particle diameter specified by JIS K1474, a bulk density is a bulk density specified by JIS K1474, and an ORVR adsorption amount is a relative value when the amount of adsorption of pellet-shaped activated carbon is assumed to be 100.

TABLE 1

| | Average particle | R/r value of | Degree of | Degree of | Average | Average |
|---|---|---|---|---|---|---|
| | diameter of | molded heat | circularity of | circularity of | particle | maximum |
| | molded heat | storage | activated | molded heat | diameter of | diameter of |
| | storage material | material | carbon | storage material | activated | protrusions |
| | (mm) | (—) | (—) | (—) | carbon | (μm) |
| Working | 1.37 | 0.64 | 0.98 | 0.92 | 1.49 | 592 |
| Example 1 | | | | | | |
| Working | 1.22 | 0.60 | 0.98 | 0.94 | 1.49 | 659 |
| Example 2 | | | | | | |
| Working | 1.22 | 0.60 | 0.98 | 0.94 | 1.49 | 659 |
| Example 3 | | | | | | |
| Comparative | 0.93 | 0.49 | 0.98 | 0.86 | 1.49 | 461 |
| Example 1 | | | | | | |
| Comparative | 1.21 | 0.50 | 0.98 | 0.88 | 1.49 | 537 |
| Example 2 | | | | | | |
| Comparative | 1.56 | 0.49 | 0.98 | 0.89 | 1.49 | 405 |
| Example 3 | | | | | | |
| Reference | 2.24 | 0.48 | 0.91 | 0.93 | 2.2 | — |
| Example 1 | | | | | | |

TABLE 2

| | Ratio of | | | | |
|---|---|---|---|---|---|
| | average particle | Bulk | | | |
| | diameter of | density | | | |
| | molded heat | of | Latent | | |
| | storage material | molded | heat of | | |
| | to average | heat | molded | | ORVR |
| | particle diameter | storage | heat storage | | adsorp- |
| | of activated | material | material | Dispers- | tion |
| | carbon | (g/mL) | (J/g) | ibility | amount |
| Working | 0.92 | 0.52 | 190 | ∘ | 183 |
| Example 1 | | | | | |
| Working | 0.82 | 0.52 | 186 | ∘ | 200 |
| Example 2 | | | | | |
| Working | 0.82 | 0.52 | 186 | ∘ | 200 |
| Example 3 | | | | | |
| Compar- | 0.62 | 0.54 | 192 | x | 176 |
| ative | | | | | |
| Example 1 | | | | | |
| Compar- | 0.81 | 0.54 | 192 | x | 176 |
| ative | | | | | |
| Example 2 | | | | | |
| Compar- | 1.05 | 0.52 | 181 | x | 167 |
| ative | | | | | |
| Example 3 | | | | | |
| Reference | 1.02 | 0.53 | 182 | ∘ | 121 |
| Example 1 | | | | | |

The following will describe a method for measuring various values.

### <Method for Measuring R/r Value>

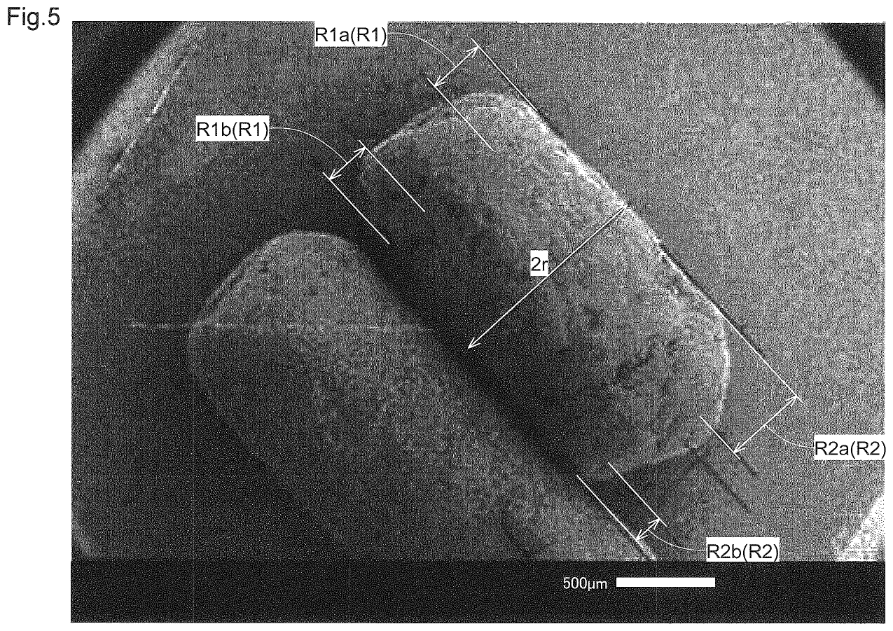

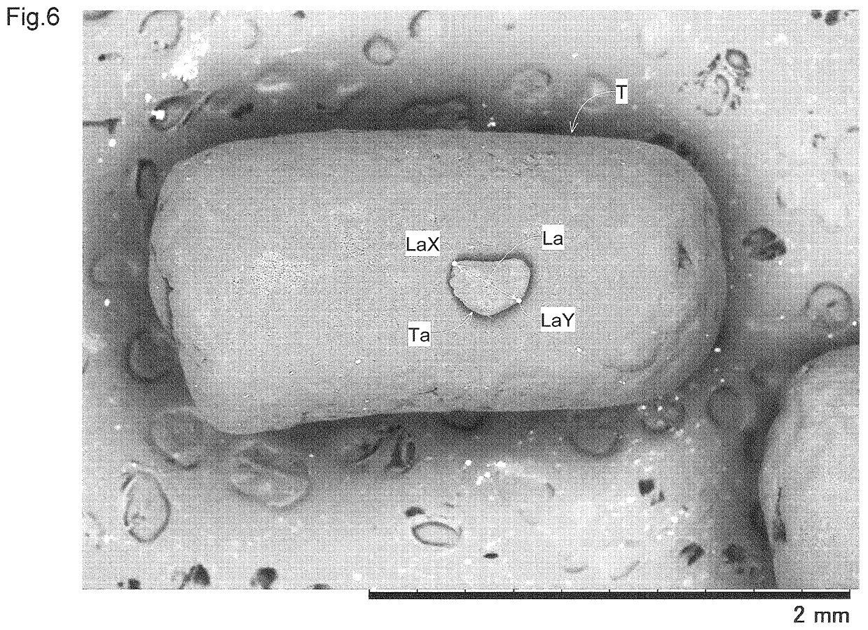

As shown in FIG. 5, an image of the molded heat storage material T was captured using a scanning electron microscope and was printed on paper, R and r were measured for 10 samples, and the average R/r value is calculated.

Here, in the above-described embodiments, it is assumed that the average value of R1/r and R2/r of the molded heat storage material T is calculated, where R1 represents the length of a curved surface of a first edge portion connecting the first end surface M2 and the circumferential side surface M1 around a column axis P2, in a radial direction of the first end surface M2 on a first end side of the column axis P2, when viewed in a direction orthogonal to the column axis P2, R2 represents the length of a curved surface of the second edge portion connecting the second end surface M3 and the circumferential side surface M1, in a radial direction of the second end surface M3 on a second end side of the column axis P2, and r represents the radius of a cross section of the molded heat storage material T taken along the direction orthogonal to the column axis P2.

Note that, as shown in FIG. 5, the length R1 of the curved surface of the first edge portion connecting the first end surface M2 and the circumferential side surface M1 around the column axis P2 may include a first end curved surface R1a and a second end curved surface R1b that are different from each other. Also, the length R2 of the curved surface of the second edge portion connecting the second end surface M3 and the circumferential side surface M1 may include a first end curved surface R2a and a second end curved surface R2b that are different from each other.

Therefore, an average value of R1a/r, R1b/r, R2a/r, and R2b/r may be used as the R/r value, and this average value was also used in the calculation of the measurement.

### <Method for Measuring Degree of Circularity>

As shown in the conceptual diagram in FIG. 4, using an image dimension measurement device (IM-7020 manufactured by KEYENCE), light was projected on the molded heat storage material T, and the area and a circumferential length B of the projected image were measured for 100 samples. A circumference C of a circle having the same area as an average area of the projected image was calculated, and the calculated circumference C of this circle was divided by the average circumferential length B of the projected image, thereby calculating the degree of circularity.

### <Method for Measuring Average Maximum Diameter of Protrusions Ta>

A scanning electron microscope was used to capture images of the molded heat storage material T, and the maximum diameters of protrusions Ta were measured on software of the scanning electron microscope. The maximum diameters of the protrusions Ta of 10 pieces of molded heat storage material T were measured, and the average maximum diameter of protrusions Ta whose maximum diameters are 100 μm or more was calculated.

Here, a protrusion that protrudes from the surface of the molded heat storage material T to the outer side and has a protrusion length from the surface to the outer side of 50 μm or more is defined as the protrusion Ta. When the protrusion Ta is observed in the protruding direction, the largest distance from one point to another point on the circumference of a protrusion Ta is defined as the maximum diameter of the protrusion Ta, and the average of the maximum diameters of protrusions Ta of 10 pieces of molded heat storage material T is defined as the average maximum diameter of the protrusions Ta.

### <Method for Measuring Dispersibility>

160 mL of molded heat storage material T and 840 mL of activated carbon were poured into a predetermined container. Then, by placing the entire container including the activated carbon and the molded heat storage material T on a vibration exciter (model number VP-15D, manufactured by Symphonia Technology Inc.) and applying vibration to the container for about 120 seconds, the activated carbon and the molded heat storage material T were mixed. The mixing state was visually checked.

### <Method for Measuring ORVR Adsorption Amount>

The casing 10 of the canister 100 of a predetermined capacity was filled with 1000 mL of mixture obtained by mixing an activated carbon and the molded heat storage material T so that the ratio by weight of the molded heat storage material T is 0.25. Only in Working Example 3, the canister was divided evenly into four sections in the fuel flow direction, and the area on the side closest to air was filled only with the adsorbing material Q and not with the molded heat storage material T. Refueling conditions (ORVR test conditions defined by EPA) were such that the temperature of liquid gasoline remaining in the fuel tank 12 was set to 26.7° C., the temperature of gasoline to be fed was set to a common predetermined refueling temperature, and the condition for stopping gasoline to be fed was set to 3000 ppm breakthrough. As a pretreatment of the activated carbon and the molded heat storage material T, gasoline was repeatedly refueled six times to adsorb and desorb vapor gasoline to the activated carbon, and then the vapor gasoline was adsorbed to the activated carbon in the form of refueling gasoline fuel until 2 g breakthrough was obtained. Then, air was caused to flow as purge gas to desorb vapor gasoline from the activated carbon.

As shown in [Table 1] and [Table 2], it can be said that in Working Examples 1 to 3 where the R/r value is 0.57 or more, the dispersibility is good, and in Comparative Examples 1 to 3 where the R/r value is less than 0.57, dispersibility is degraded.

Also, it can be said that in Working Examples 1 to 3 where both the activated carbon and the molded heat storage material T have a degree of circularity in the range of 0.9 or more and 1.0 or less, the dispersibility is good, and in Comparative Examples 1 to 3 where at least one of the activated carbon and the molded heat storage material T has a degree of circularity out of the range of 0.9 or more and 1.0 or less, the dispersibility is degraded.

Incidentally, in Reference Example 1, although the R/r value is 0.48, which is less than 0.6, the dispersibility is good, the reasons of which are estimated to be, for example, the activated carbon and the molded heat storage material T having a large average particle diameter and having the degree of circularity within the range of 0.9 or more and 1.0 or less.

Furthermore, in Working Examples 1 to 3 and Comparative Examples 1 to 3 where the molded heat storage material T has an average particle diameter in a range of 0.9 mm or more and 1.6 mm or less, and the activated carbon has an average particle diameter in a range of 1.0 mm or more and 1.8 mm or less, relatively high ORVR adsorption amount are given, whereas in Reference Example 1 where the molded heat storage material T has an average particle diameter that is out of the range of 0.9 mm or more and 1.6 mm or less and the activated carbon has an average particle diameter that is out of the range of 1.0 mm or more and 1.8 mm or less, the ORVR adsorption amount is lower than those in Working Examples 1 to 3 and Comparative Examples 1 to 3. Based thereon, it can be said that by setting the particle diameter range specified in the present embodiment, the amount of adsorption can be increased.

Also, as shown in Working Examples 1 to 3, it was confirmed that the protrusions Ta with the average maximum diameter of at least 592 μm or less did not affect the ORVR adsorption amount, and adsorption performance of a certain level or above could be achieved.

### OTHER EMBODIMENTS

(1) The above embodiment has described configuration examples where the adsorption layer K is a single adsorption region and where two adsorption regions, namely, the tank-side adsorption region K2 and the air-side adsorption region K1, are provided, but a plurality of adsorption regions may be provided as the adsorption layer K.

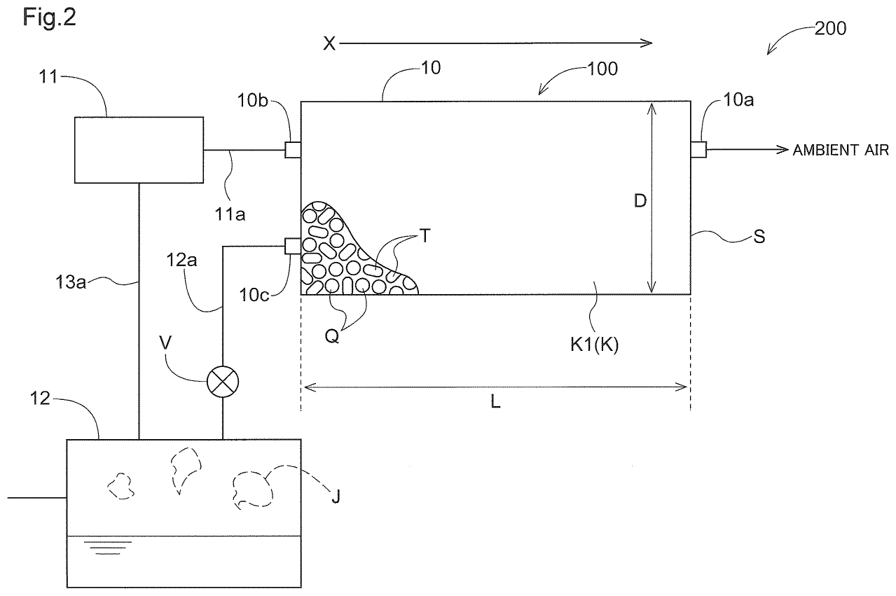

Also, the above embodiment has described configuration examples where the tank-side adsorption region K2 and the air-side adsorption region K1 are separated from each other by the separation film, but a configuration is also possible in which, as shown in FIG. 2, no separation film is provided.

Furthermore, a configuration is also possible in which between the tank-side adsorption region K2 and the air-side adsorption region K1, the mass ratio of the molded heat storage material T to the adsorbing material Q (activated carbon) changes in a stepwise manner along the flowing direction X of fuel vapor J.
(2) Instead of the molded heat storage material T having a columnar shape, a molded heat storage material T having various shapes such as a square tubular shape may be used.

Note that the configurations disclosed in the above embodiment (including the other embodiments, the same applies hereinafter) can be applied in combination with configurations disclosed in other embodiments as long as no contradiction arises. Also, the embodiments disclosed in the present specification are examples, and embodiments of the present invention are not limited to the disclosed embodiments, and it is possible to modify the embodiments as appropriate within a scope not departing from the object of the present invention.

### INDUSTRIAL APPLICABILITY

A canister according to the present invention, and an automotive vehicle provided with such a canister can be effectively applicable as a canister that can be downsized, and in which: an adsorbing material in an adsorption layer can have an improved adsorption ability; classification is suppressed while improving the dispersibility of a molded heat storage material with respect to the adsorbing material; and adsorption heat generated from the adsorbing material during adsorption is effectively stored in the heat storage material to suppress an increase in temperature of the adsorption layer and achieve a further improvement in the adsorption ability, as well as an automotive vehicle provided with such a canister.

### DESCRIPTION OF REFERENCE SIGNS

10: Casing
10a: Air port
10b: Purge port
10c: Tank port
12a: Vapor flow path
100: Canister
200: Automotive vehicle
J: Fuel vapor
K: Adsorption layer
K1: Air-side adsorption region
K2: Tank-side adsorption region
Lb: Protrusion length
M1: Circumferential side surface
M2: First end surface
M3: Second end surface
M2a: First edge portion
M3a: Second edge portion
P2: Column axis
Q: Adsorbing material
R1: Length of curved surface of first edge portion
R2: Length of curved surface of second edge portion
T: Molded heat storage material
Ta: Protrusion
V: On-off valve
X: Flowing direction
r: Diameter of cross section

1. A canister for an ORVR system comprising a casing internally provided with an adsorption layer capable of adsorbing and desorbing fuel vapor, wherein:
the adsorption layer contains an adsorbing material, and a molded heat storage material molded from microcapsules in which a phase change substance is encapsulated, the phase change substance configured to absorb and release latent heat according to a temperature,
the molded heat storage material is a heat storage material that has an average particle diameter of 0.9 mm or more and 1.6 mm or less and is molded in a columnar shape, and the adsorbing material has an average particle diameter of 1.0 mm or more and 1.8 mm or less, and
the molded heat storage material comprises a first end surface on a first end side of a column axis of the columnar molded heat storage material, and a second end surface on a second end side of the column axis, when viewed in a direction orthogonal to the column axis, and an average value of R1/r and R2/r is 0.57 or more, where R1 represents a length of a curved surface of a first edge portion, which connects the first end surface and a circumferential side surface around the column axis, in a radial direction of the first end surface, R2 represents a length of a curved surface of a second edge portion, which connects the second end surface and the circumferential side surface, in a radial direction of the second end surface, and r represents a radius of a cross section of the molded heat storage material, in the direction orthogonal to the column axis.

2. The canister according to claim 1,
wherein the molded heat storage material comprises protrusions protruding from a surface of the molded heat storage material to an outer side, and each of the protrusions protruding from the surface to the outer side has a protrusion length of 50 μm or more, and
wherein letting a largest distance from one point to another point on a circumference of a protrusion when viewed in a protruding direction in which the protrusion protrudes be a maximum diameter of the protrusion, and an average of maximum diameters of a plurality of protrusions be an average maximum diameter, the average maximum diameter of protrusions has a maximum diameter of 100 μm or more is 800 μm or less.

3. The canister according to claim 1,
wherein a ratio of an average particle diameter of the molded heat storage material to an average particle diameter of the adsorbing material is 0.6 or more and 1.3 or less.

4. The canister according to claim 1,
wherein, letting an area of a projected image of an object be S, a circumferential length of the projected image be B, and a circumferential length of a circle having the same area as the area S of the projected image be C, a degree of circularity is defined as C/B, and
wherein the adsorbing material has a degree of circularity of 0.90 or more and 1.0 or less, and the molded heat storage material has a degree of circularity of 0.90 or more and 1.0 or less.

5. The canister according to claim 4,
wherein a ratio of an average particle diameter of the molded heat storage material to an average particle diameter of the adsorbing material is 0.6 or more and 1.3 or less.

6. The canister according to claim 5,
wherein the casing comprises a tank port communicating with a fuel tank, a purge port for discharging purge gas, and an air port communicating with ambient air, with the tank port and the purge port provided at one end of the casing and the air port being-provided at another end of the casing, and
wherein the adsorption layer has a lower mass ratio of the molded heat storage material to the adsorbing material in a region adjacent to the tank port and the purge port than in a region adjacent to the air port.

7. The canister according to claim 6,
wherein the adsorption layer comprises a tank-side adsorption region located close to the tank port and the purge port, and an air-side adsorption region located close to the air port, a mass ratio of the molded heat storage material to the adsorbing material in the air-side adsorption region is 0.15 or more and 0.80 or less, and a mass ratio of the molded heat storage material to the adsorbing material in the tank-side adsorption region is 0.05 or more and 0.50 or less.

8. The canister according to claim 7,
wherein the molded heat storage material in the tank-side adsorption region has a melting point that is lower than a melting point of the molded heat storage material in the air-side adsorption region.

9. The canister according to claim 8, further comprising,
an on-off valve provided on a vapor flow path through which the fuel tank and the tank port are in communication with each other, the on-off valve being-capable of opening and closing the vapor flow path.

10. The canister according to claim 9,
wherein the molded heat storage material has a bulk density of 0.40 g/mL or more and 0.60 g/mL or less.

11. The canister according to claim 10,
wherein the molded heat storage material has a latent heat of 150 J/g or more and 200 J/g or less.

12. The canister according to claim 11,
wherein the adsorption layer in the casing of the canister has L/D/S of 0.07 or less, where L represents a length of the adsorption layer in a flowing direction of fuel vapor, S represents an area of a cross section of the adsorption layer taken along a direction orthogonal to the flowing direction, and D represents a diameter of a cross section of the adsorption layer that is taken along the direction orthogonal to the flowing direction and is a perfect circle.

13. (canceled)
